(19) United States
(12) Patent Application Publication
(10) Pub. No.: US 2024/0265288 A1
(43) Pub. Date: Aug. 8, 2024

(54) Systems and Methods Involving Uniform Quantum Computing Model(s) based on Virtual Quantum Processors, Aspects of Quantum Information Technology and/or Other Features

(71) Applicant: QUANTUM SCIENCE & SYSTEMS GMBH, Wien (AT)

(72) Inventor: Georg Gesek, Vienna (AT)

(21) Appl. No.: 18/564,595

(22) PCT Filed: Jun. 1, 2022
(86) PCT No.: PCT/EP2022/064964

§ 371 Date: Nov. 27, 2023

Related U.S. Application Data
(60) Provisional application No. 63/195,692, filed on Jun. 1, 2021.

(51) Int. Cl. G06N 10/40; G06N 10/20

(52) U.S. Cl. CPC G06N 10/40; G06N 10/20

(57) ABSTRACT

The present innovations relate to systems and methods associated with performing virtualized quantum processing. According to embodiments herein, an exemplary method may involve initializing qubits with classical meta information, initializing gate circuits between the qubits with the classical meta information, processing a given quantum circuit by transforming all qubits by unitary matrices, measuring the qubits to retrieve classical information, and processing the classical information, wherein the method is implemented via an information process stack, preferably comprised of a hardware layer, an operating system coupled to the hardware stack, and a container environment coupled to the operating system. In some implementations, a Bloch sphere is built into an intermediate representation of a memory pattern within the main memory in such a way that associated same state vectors |ψ> are fully represented within the memory pattern along with the classical information |0> and |1>.

### CROSS-REFERENCE TO RELATED APPLICATION(S) INFORMATION

This International PCT Patent application claims priority to U.S. provisional patent application No. 63/195,692, which is incorporated herein by reference in entirety.

### BACKGROUND AND DESCRIPTION OF RELATED ART

Certain background art relates to the field(s) of Computer Science, Quantum Information Theory, Quantum Physics, Computer Architecture, Quantum Processing and/or Storing Components with their Physical Structure.

As background, conventional computers are based on the theory of computation mainly by Alan Turing and different architectural concepts like the one by John von Neumann. Thus, todays computers used for many applications in industry and commercial products are so-called Turing machines which basically transform a set of input states, called data, into a set of output states, also being data, which is also named the ‘result’ or the ‘solution’ of a problem. The computation in between, which generates this transformation of data, is called an algorithm, since the Turing machine is only capable of sequentially execution of mathematical functions which are hard-wired in the central processing unit's Arithmetic and Logic Unit (ALU). The program itself consists therefor of a set of so-called machine codes, which simply select the ALU's functions one after the other. One can encode a mathematical problem in such a program for a Turing machine and if the Turing machine will stop the execution after a finite number of steps, the problem is solved by a finite result, which is another set of data.

All Turing machines (such as the exemplary one shown in FIG. 1) have in common that they can be physically built by means of classical mechanics. In that way, Turing machines are highly predictable, theoretically deterministic, which is expressed by the fact that a certain set of input data will every time result in the same set of output data, regardless how often the program is being executed. The Turing machine is also limited in its capability only to execute one program step after the other, sequentially. One can run a larger number of Turing machines side by side, but as soon as it comes to an interaction between them via data exchange, one Turing machine has to wait for the result of the other.

The fundamental solution for this issue are new types of computational machines, like neural networks or quantum computers. Quantum computers are a totally different approach to overcome the fundamental computational limits of Turing machines, which are no longer based on classical deterministic mechanics, but directly on quantum mechanics. Further, a Hybrid Quantum Computer that is capable of both, quantum and sequential deterministic algorithms may be desirable, in various instances. One example of related art of this nature is set forth in WO2020/106777A1. Various embodiments of such related art can be further explained with reference to the attached drawings FIGS. 1-4. For instance, FIG. 1 is a block diagram of a known Turing machine. FIG. 2 is a block diagram of an exemplary universal quantum machine, consistent with exemplary aspects of certain embodiments of the present disclosure. FIG. 3 is a block diagram of an exemplary hybrid quantum computer, consistent with exemplary aspects of certain embodiments of the present disclosure. FIG. 4 is a block diagram of an exemplary hybrid quantum processor, consistent with exemplary aspects of certain embodiments of the present disclosure.

As indicated above, while some theoretical concepts of such machines have already been proposed and/or are known regarding quantum computers, some major achievements were still missing in order to realize a commercial successful implementation of a quantum computer. First, for example, a model for a universal quantum machine defining technical solutions to the existing technical problems of the quantum analogue to the computational class of Turing machines and their connection to the classes of computational complexity was missing. Second, a physical implementation of a hybrid quantum computer also having technical solutions to the existing technical problems of cache coherency between different kinds of processing units while maintaining the high bandwidth of data exchange between them, as needed to achieve quantum information processing in practice, was also missing. Various technical solutions regarding both of these innovations and/or how other drawbacks of the known art are overcome are described herein.

### Overview

Systems and methods involving and/or related to a uniform computing model are disclosed. In certain illustrative implementations, an exemplary uniform computing model that is based on hybrid quantum computing and hardware-agnostic features, functionality, and/or processing may be utilized/provided, such as via a virtual quantum processor utilized to emulate a generic hybrid quantum machine based on a set of instructions within a Turing machine. Systems and methods herein may utilize more generic implementations of Hybrid Quantum Computing, e.g., on one hand hardware agnostic, but still anticipating the fundamental laws of nature which rule any future quantum computing system, regardless of its engineered excellence. Related aspects and advantages, here, are implemented via a Virtual Quantum Processor, a piece of imaginary hardware, which is constructed to emulate a generic hybrid quantum machine based on a set of instructions within a Turing machine. With such virtual quantum processor established, a Uniform Computing Model for Hybrid Quantum Software is generated, which can be applied later to any physical representation of quantum computing hardware, while running already today on current machines. In some implementations, a Bloch sphere is built into an intermediate representation of a memory pattern within the main memory in such a way that associated same state vectors |ψ> are fully represented within the memory pattern along with the classical information |0> and |1>.

### BRIEF DESCRIPTION OF THE DRAWINGS

Various embodiments of the present disclosure can be further explained with reference to the attached drawings, wherein like structures are referred to by like numerals throughout the several views. The drawings shown are not necessarily to scale, with emphasis instead generally being placed upon illustrating the principles of the present disclosure. Therefore, specific structural and functional details disclosed herein are not to be interpreted as limiting, but merely as a representative basis for teaching one skilled in the art to variously employ one or more illustrative embodiments.

FIG. 1 is a block diagram of a known Turing machine.

FIG. 2 is a block diagram of an exemplary universal quantum machine, consistent with exemplary aspects of certain embodiments of the present disclosure.

FIG. 3 is a block diagram of an exemplary hybrid quantum computer, consistent with exemplary aspects of certain embodiments of the present disclosure.

FIG. 4 is a block diagram of an exemplary hybrid quantum processor, consistent with exemplary aspects of certain embodiments of the present disclosure.

FIG. 5 is a block diagram of an exemplary Block sphere, consistent with exemplary aspects of certain embodiments of the present disclosure.

FIG. 6 is a block diagram of an exemplary set of uniform information processing hardware, consistent with exemplary aspects of certain embodiments of the present disclosure.

FIG. 7 is a block diagram of an exemplary uniform information processing hardware stack, consistent with exemplary aspects of certain embodiments of the present disclosure.

FIG. 8 is a block diagram of an exemplary virtual processor instance, consistent with exemplary aspects of certain embodiments of the present disclosure.

### DETAILED DESCRIPTION OF CERTAIN ILLUSTRATIVE IMPLEMENTATIONS

Various detailed embodiments of the present disclosure, taken in conjunction with the accompanying figures, are disclosed herein. However, it is to be understood that the disclosed embodiments are merely illustrative. In addition, each of the examples given in connection with the various embodiments of the present disclosure is intended to be illustrative, and not restrictive.

Throughout the specification, the following terms take the meanings explicitly associated herein, unless the context clearly dictates otherwise. The phrases “in one embodiment” and “in some embodiments” as used herein do not necessarily refer to the same embodiment(s), though it may. Furthermore, the phrases “in another embodiment” and “in some other embodiments” as used herein do not necessarily refer to a different embodiment, although it may. Thus, as described below, various embodiments may be readily combined, without departing from the scope or spirit of the present disclosure.

While other aspects are involved, the present disclosure focuses on a Uniform Computing model based on Hybrid Quantum Computing that is hardware agnostic. As explained in more detail, below, and consistent with the disclosed technology, systems and methods herein involving innovative utilization and/or incorporation of Turing machines for emulating a Virtual Quantum Processor, which is a generic representation of any physical implementation of such a technology. To scrutinize the fundamentals of Turing and Quantum machines, first of all, quantum computing as a special application of quantum physics is identified. Since physicists have established a very distinct mathematical model of quantum physics, within the 20th century, which is based on linear algebra in multidimensional complex vector spaces, so called Hilbert spaces, it is known at least that such quantum physics can be calculated within classical computers. This is done by calculating matrices of floating-point representations, such as the IEEE754 binary floating-point format, in software which is named a “Quantum Computing Simulator”. The term simulation as used herein refers to the representation of so-called ‘Bloch spheres’ in Turing machines. The matrices, representing the state vectors of the qubits, are operated with a certain set of classical operations for any superposition within a Turing machine, which means a shift of the two angles of the state vector. In a quantum computer, this is called a rotation gate on a single qubit and can be ideally carried out, in a single step, in parallel for any number of qubits. The Turing machine can also parallelize the calculation of superposition with such a linear extension of calculation power. Thus, there is no significant advantage for the quantum machine.

Thus, a classical computer is able to reproduce the calculations made by a quantum computer on the state vectors of its qubits and their connection with quantum gates, building the so-called quantum circuit, without errors. The difference between classical & quantum computers, and the reason for getting the latter into service, is the native processing of quantum information, which scales exponentially better while calculating these large matrices with entangled state vectors. Would it be only for the superposition of quantum information, meaning single qubit operations, they are in fact being executed in classical computers nearly as efficient as within quantum computers. But due to the possible entanglement of state vectors, the respective matrices calculations scale computer time exponentially within a Turing machine, while they don't in a quantum machine.

### 1. Technology Overview Regarding the Universal Quantum Machine

While the class of problems which can be solved by a Turing machine in polynomial time is named P, the class of problems which can be solved by a Universal Quantum machine within polynomial time may be called QP. There is also a theoretical extension to the class of P by adding a stochastic source to the Turing machine, so that it is also capable of the generation of a true random number, which leads to the class of problems which can be solved by such a Nondeterministic Turing machine in polynomial time, named NP. It should be kept in mind that there is yet no final theory of complexity classes due to the fact that it is not decided regarding whether P< or =NP and NP< or =QP. Further, one cannot yet perfectly tell a Universal Quantum machine, by definition capable of calculating all possible quantum algorithms in the least possible amount of computational time, from a Quantum machine with limitations. Nevertheless, the Quantum Information Theory contains information related to this puzzle and the Quantum Computer, such as set forth herein, will help to elaborate these subtle differences.

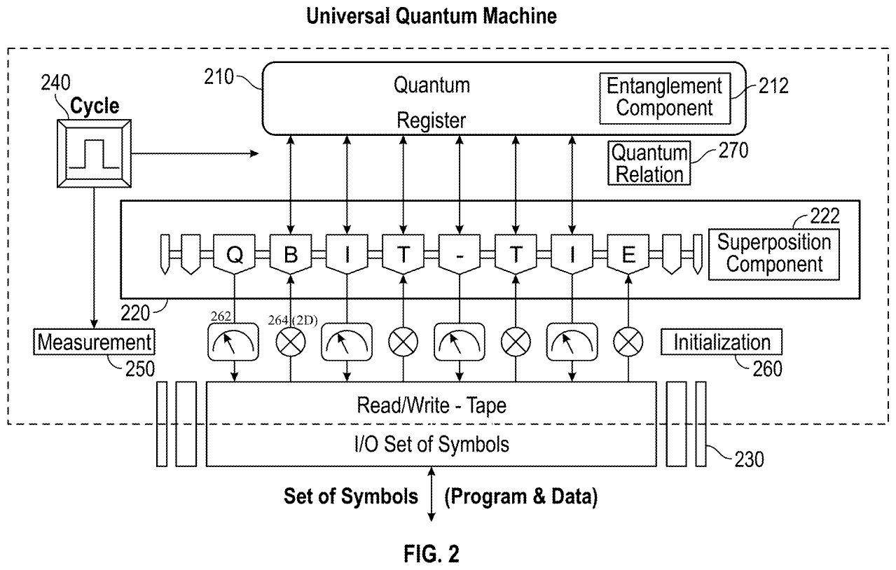

The technology described, here, may utilize and/or involve the following exemplary aspects or scheme for the general model valid with any universal quantum machine, as shown in FIG. 2. Further, aspects herein are based on the principle/insight that there are no other true stochastic sources other than quantum effects, thus quantum algorithms, in the universe. Taking this into account, the theoretical expansion of a deterministic Turing machine by a stochastic source ultimately leads to a quantum machine with limitations. On the other hand, a deterministic process is never able to produce a true stochastic source, by definition. This leads to the conclusion that P has to be <NP, since the task of producing a true random number never halts on a deterministic Turing machine, but can be easily achieved by an Indeterminate Turing machine. Since NP in that sense is a subset of QP, it is believed to follow that QP>NP>P.

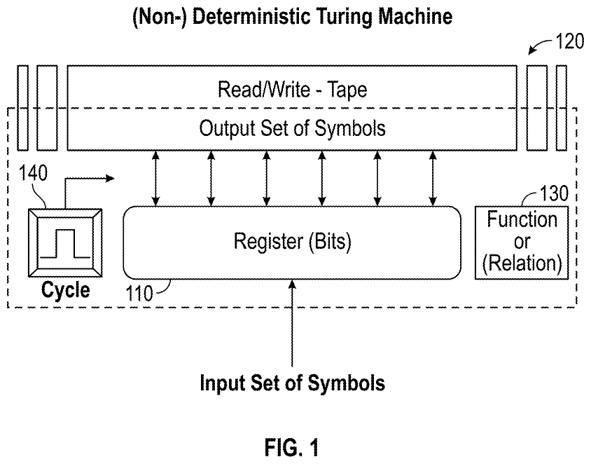

As explained in connection with FIGS. 1 and 2, a comparison of the architectures of a Turing machine and a universal quantum machine is explained as follows. Referring to FIG. 1, such Turing machine may include a register 110 of conventional bits, which can be directly fed from an external source of symbols (input set of symbols), and then being interpreted by the machine as program instructions or data. The language is fairly easy, there are commands to move the memory band 120 (read/write-tape) connected to the register, as well as commands for writing or reading the symbols on this band. The individual positions on the tape are well defined, in computer terms, i.e., such positions are “addressable”. Each process step of the computer program is temporally separated from the other by the means of a clock 140 (cycle).

Apart from the program commands to move, read and write the tape on arbitrary positions, the arithmetic & logic unit 130 (ALU) of the Turing machine may implement all necessary mathematical functions, in order to perform all kinds of operations. Functions that are more complex can be split into a set of easier functions. This is where the so-called deterministic Turing machine differs from the non-deterministic. While the deterministic Turing machine has only functions available that can produce only one specific output from a certain input, the non-deterministic Turing machine has the capability of a relation as well, which is therefore able to produce several versions of outputs from only one set of input. The version of the possible results selected is purely random, determined by a non-predictable, stochastic source. The so-called non-deterministic Turing machine (NDTM) therefore is not the opposite of the deterministic (DTM) variant, but has to be understood as relational extension to it.

Turning back to the technology, discussed here, aspect may include and/or involve the system(s)/implementation(s) set forth in FIG. 2, which achieves the archetype of the universal quantum machine, and which is capable of both quantum and sequentially deterministic operation as well as nondeterministic algorithms.

From outside, seen as a black box, the illustrative universal quantum machine (UQM) illustrated in FIG. 2 works analog to the non-deterministic Turing machine (NDTM), which also allows ambiguous relations. From one and the same input set, therefore, different output sets can derive, which makes the result of the universal quantum machine partly unpredictable. Between the sets of input and output lies an algorithm which includes quantum relations.

Regarding differences between the universal quantum machine and the Turing machine, the quantum information stored within the quantum register 210 (upper area in the figure) cannot be copied due to non-cloning-requirement imposed by quantum mechanics, unlike classical information. This is so because interaction with the quantum machine is needed in order to make an input, which would cause the quantum information inside the register to be nullified, deleted or destroyed. However, the quantum register merely stores quantum states, which would be destroyed by such an effort.

Therefore, the presently-described quantum machine not only uses the classical read-write-tape 230 for the output of the calculation result, but also for the return of values stored in the register as well as for the inclusion of the input data. To perform quantum algorithms at all, a suitable physical process of ‘initialization’, i.e. introduction, is first employed to transfer these classic, and therefore deterministic, data sets, into quantum states 260, which are referred to herein as qubits. These qubits are stored on a qubit tape 220, which is referred to in FIG. 2 as the “QBIT-TIE”. In that manner the classical bits become super positioned qubits, which can be directly read, written, and processed by the quantum register. The operation here is analog to the Turing machine, but instead of classical algorithms, quantum algorithms 270 come into action and instead of data stored on classical bits, the information resides on qubits. The quantum register is capable of entanglement of qubits and the qubit-tie provides superpositioning of qubits. As shown in the exemplary implementation of FIG. 2, such entanglement may be provided via an entanglement component 212 within the quantum register 210, and such superposition may be provided via a superposition component 222 within the qubit-tie computing component 220.

Here, it is further noted that, while the expression “tape” is used herein for legacy reasons, e.g. as a term of art, such storage media may encompass one or more of any memory technology beyond traditional tape (e.g., magnetic) storage.

To emit a calculation result by such quantum machine, it is not enough just to read the output of the read-write-tape, but the inverse process to the initialization must be performed beforehand, namely a measurement 250 of the qubits, as represented by the instrument symbols in FIG. 2. This measurement includes the stochastic effect, that of the superposed states which occur in a qubit, according to inherent probabilities, which in turn result from the previously established quantum gates in the register, and result in partly deterministic and random, classical output quantities, referred to as output bits. These output bits are written equally (e.g., via such previously established quantum gates), such as by the Turing machine on the classical memory tape 230, and are available either as a result, or as a classical cache for the algorithm of the universal quantum machine. It is apparent therefore that such universal quantum machine is capable of performing both classical as well as quantum algorithms, thus enabling it to emulate an entire Turing machine. Indeed, most of the known quantum algorithms, like the one by Shore, use both classical and quantum functions, which are alternately composed.

As can be seen, evidence establishes that the quantum machine described here is universal, e.g. over any suggestion that all existing quantum relations have not been discovered: firstly, all physical models, which describe the natural quantum systems in the universe, are merely composed of superposition and entanglement. Secondly, the inventors work in Quantum Information Technology (QIT), shows with its fundamental graph theory that all possible arrangements of information stored in the universe are fully described by superposition and entanglement. Hence, the universal character of the architecture shown in FIG. 2, i.e., the universal quantum machine, may be defined and established within this context.

### 2. Physical Implementation(s) of a Hybrid Quantum Computer

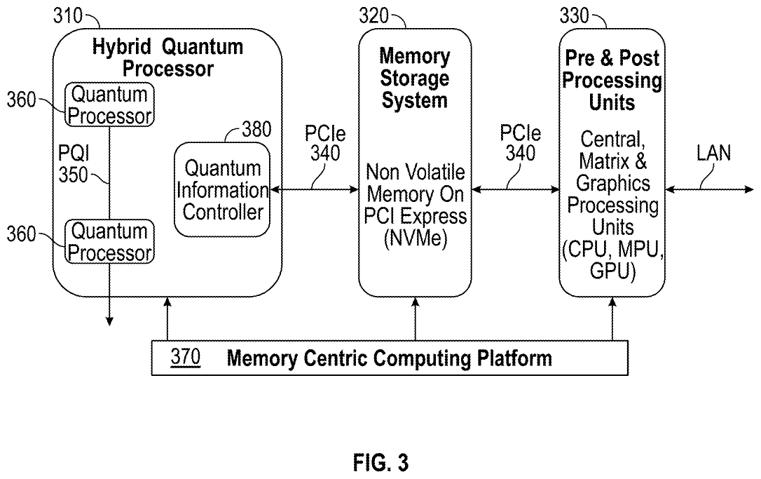

In order to achieve and describe the realization of the universal quantum computer in a full and reasonably succinct manner, such technology is explained based on existing Turing machines, also called servers, and, furthermore, the building blocks of the quantum part, which is implemented in the quantum processor 360, as shown in FIG. 3.

FIG. 3 is a block diagram of an exemplary hybrid quantum computer 300, consistent with exemplary aspects of certain embodiments of the present disclosure. Referring to FIG. 3, system elements including pre- & post-processing units 330, e.g., a Turing processor such as Novarion's Quanton™ Servers, may be utilized to provide the classical part of the universal quantum machine, the read-write-tape, which is realized as a so-called PCI (Peripheral Component Interconnect) express bus 340, or PCIe, as shown in FIG. 3, which, again, illustrates a high-level, exemplary block diagram of a hybrid quantum computer.

To add the quantum computing parts by industrial means, implementations herein may incorporate such quantum computing parts into a Quantum Processing Unit or QPU 360. In order to combine the classical and quantum parts of the hybrid quantum computer in accordance with operational needs, i.e. so that they can be interconnected smoothly and cooperate with high-performance, the classical and quantum processors are arranged in a memory centric computing architecture, including a memory storage system 320, as shown in the exemplary system of FIG. 3. In some implementations, such memory storage system may be implemented via certain storage systems, i.e., Novarion's PlatinStor™ Storage Systems. In general, such memory storage system 320 may comprise non-volatile memory banks configured to be directly addressed by the PCIe bus, both from the pre- & post processing units 330 and from the hybrid quantum processor platform 310, simultaneously. In order to not compromise the data while being transferred, a key feature of such memory storage system 320 is the inbuilt cache coherence which acknowledges writes only when the data has been physically written and is available for physical read operations of another device. In this manner, this memory storage system 320 has been designed specially to support the memory centric computing platform required, here, which is key to the overall functionality of the hybrid quantum computer introduced herein.

Aspects of the illustrative architecture of FIG. 3 for the hybrid quantum computer may utilize existing industrial technology, such as different kinds of pre- & post-processing units 330 or Turing processors (such as Novarion's Quanton™ processor, for example), a memory storage system 320 (e.g., non-volatile memory banks, such as PlatinStor™, above), and a PCIe bus 340 to connect the building blocks. As shown in FIG. 3, the Pre- & Post-Processing Units 330 or Turing processors may comprise the general components shown in FIG. 1. Further, in some embodiments, the Pre- & Post-Processing Units 330 or Turing processors may be configured, like Quanton™, to utilize all different kinds of classical processing units, especially at least though not exclusively, central processing units (CPU), matrix processing units (MPU), graphics processing units (GPU) or even neural networks. Every kind of XPU is required to use the inbuilt memory controller within the Pre- & Post-Processing Units 330 which grant access for the XPU components to the centralized memory architecture provided by memory storage system 320 via the PCIe bus.

Further, it is noted that, while certain existing subcomponents of the memory centric computing platform have been developed by the industry, aspects of the present systems and methods may involve innovations stemming as a function of the software and hardware around the PCIe bus, such as via implementation of a cache coherent dataflow between heterogeneous processing units (XPU, QPU) by means of a memory centric architecture. In addition, it is noted that both the pre- & post-processing units 330 (such as the Quanton™ Server System) and memory storage system 320 (such as PlatinStor™) have been already developed by Novarion for interrelated application.

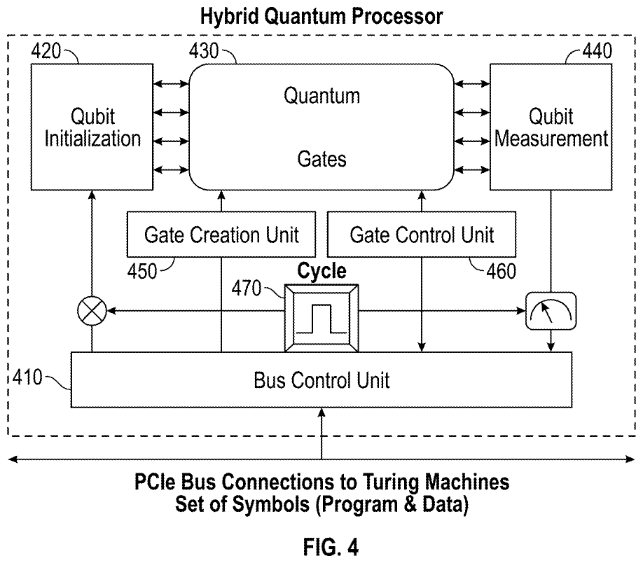

The Hybrid Quantum Processor 310 consistent with the present innovations, also referred to as the IONICS computing platform, is one focus of the presently described inventions, and may be connected to the memory centric computing architecture via the PCIe bus 340 as shown in FIG. 3. The hybrid quantum processor 300 incorporates a plurality of quantum processors, which are connected by a new Photonic Quantum information Interface (PQI) 350. One innovative component of the hybrid quantum processor is the quantum processor core 360, which functioning as shown in FIG. 2 and may be constructed as set forth in FIG. 4.

FIG. 4 is a block diagram of an exemplary hybrid quantum processor 400, consistent with exemplary aspects of certain embodiments of the present disclosure. Referring to FIG. 4, the illustrated architecture separates the classical computing part from the quantum machine—the Quantum gates, which are the arithmetic & logic unit (ALU) 430 built on the qubits—but connects both by a relatively high performing and scalable bus system which is based on industry standards (PCIe). The hybrid quantum processor 400 may be mounted and connected on a printed circuit board (PCB)—motherboard—and consists of a Bus Control Unit 410 (BCU), which is realized as an IC (integrated circuit—FPGA), a Gate Creation Unit 450 (GCRU), which converts the electronic signals from the BCU into parameter for the ALU 430 to superposition and entangle the qubits.

Such hybrid quantum processor, e.g., as in FIG. 4, makes an important architectural difference to any other qubit implementation so far, since the gate creation unit 450 and the gate control unit 460 separate the bus control unit 410 from the quantum register and thus represent the qubit-tie 220 between the classical bus control unit and the quantum register 430, which contains the quantum gates. Additionally, the Gate Control Unit 460 (GCU) performs manipulations on the qubits, which make them immune against disturbances that otherwise cause errors during the performance of quantum information transactions within the quantum gates 430. These qubit control functions are error-correcting operators, which can be implemented as state-of-the-art algorithms and programmed by the bus control unit as a firmware upgrade, e.g., into an existing installation of the hybrid quantum computer operating in a data center.

The qubit initialization 420 creates a set of qubits, up to as many as the Quantum ALU possesses 430 and delivers the quantum information input to the quantum gates 430. The result of the quantum information processing will be retrieved by the qubit measurement units 440 on the right of the quantum ALU (Q-ALU). The measurement results are conveyed to the bus control unit 410 (BCU) where they find a classical memory cache in order to be further transferred via the PCIe bus to the classical memory centric computing architecture and their attached classical processors. The Quantum processor is synchronized by a clock 470 (cycle), which allows the production, processing and measurement of a high number of superpositioned and entangled qubits per time unit. Thus, the calculation power of the hybrid quantum processor is highly scalable in both the number of entangled and superpositioned qubits as well as the number of quantum calculations per second.

The Q-ALU (qubit Arithmetic & Logic Unit 430) shown and discussed herein is capable of all possible entangled and superpositioned states of the qubits. The qubits inhere quantum information and define a lattice of quantum gates at the same time. With these prerequisites, implementations herein incorporate the representation of all possible quantum states and functions within the Q-ALU. Thus, the present Hybrid Quantum Processor is really a Universal Quantum machine, as defined by the statements in Section 1.

The control unit itself is a Turing machine and hence capable of feeding back classical information to the Q-ALU, via the gate control unit. This feature can be used for instantaneous error correction and, further, the present Quantum processor can autonomously perform whole sets of quantum algorithms and return the results to the classical processor within the server. Systems and methods herein allow the efficient use of the PCIe bandwidth and avoid latency via the PCIe bus.

Since the PCIe system herein is a bus system, implementations herein may connect more than one Quantum processors of this type to several and different conventional processors within the servers. Further, integration of all described parts on a single microchip may be implemented, so that there is a high-speed connection between the Quantum and the classical computing parts. With such integration, the solution is not only useful for servers in data centers, as described by way of example herein, but also for personal computers, smartphones and embedded systems in cars, airplanes and so forth.

### 3. Technical Features/Aspects for Implementation of a Hybrid Quantum Processor

The inventor's existing findings in Quantum Information Theory explain how a Quantum Information System (QIS) can be used as Quantum Computer. In the following, it is described for the first time, under which conditions a Quantum Information System (QIS) is implemented and utilized as a high-performance Quantum Computer, which principles are part of this invention. The concepts in capital letters are the known notions:

### 1 st Decoherence & the Principle of Isolation:

the QIS utilized herein is self-contained in a way that other entities of the Universe, apart from the qubit initialization unit, the gate creation unit, the gate control unit and the qubit measurement system, cannot influence or interact with the Q-ALU of the Quantum processor

### 2nd Fidelity & the Principle of Limitation:

according to physical implementation herein, the elements (particles) of the QIS, which carry the Quantum information—qubits in the Q-ALU—used for the calculation, provide physical qualities, which can be superpositioned and entangled at the same time. Since the particles themselves consists of quantum information, according to the Theory of Quantum Information, they can be superpositioned and entangled by themselves. The physical implementation of the qubits therefore is made in such a manner, that the degrees of freedom of the whole QIS are as much as possible limited to the qubit operations on the selected physical parameters. This limits possible errors during the quantum calculation, which is vital to the success of such an implementation.

### 3rd Complexity & the Principle of Manifold:

although theorists prefer to have QIS described with their well known, highly functional theories in place, an overarching power of the present Quantum Arithmetic and Logic Unit is unleashed by a manifold on different paths of superposition and entanglement. This means that the present advanced quantum computation capabilities cannot be handled by explicit theoretical formalism but inherently on a structural level, like the description of the functionality of a neural network. Thus, the programming of such Hybrid Quantum Computer is not by the definition of algorithms by a software engineer, but there has to be rather a mathematician, the “quantum gate developer”, to build structures for the quantum arithmetic and logic unit, which then can be autonomously and newly introduced with any next step in calculation, e.g., by the Quantum processor discussed herein. Using this principle of manifold in quantum gates, the present quantum machine is a hardware virtualization entity, where hardware and software together is subject to change with any application.

According to the inventor's Theory of Quantum Information, a new understanding of the phenomena of entanglement and superposition was introduced

Entanglement thereby, the inventor describes as the sharing of a certain quantum information between different entities (=QIS) in the universe. Hence, one can use any physical process to entangle qubits, which changes their states, even if this change is carried out independently on all respective parties, such as Qubits in a Universal Quantum Computer.

Superposition thereby, the inventor describes as the overlap of different pieces of quantum information on one entity (=QIS) in the universe. Hence, different quantum gates can be constructed using the same qubits simultaneously in a Universal Quantum Computer.

### 4. Physical Building Blocks for Qubits

According to the given principles in Section 3 for the physical systems used in the present Q-ALU, namely Isolation, Limitation & Manifold, various explicit examples of the possible physical entities as building blocks for qubits are as follows

### Photons & Electrons

One of the most accurate theories which humans have ever achieved is the theory of Quantum Electro Dynamics (QED), which describes the interactions between photons and electrons. This is because both particles, according to the aforementioned QIT, represent the simplest components of the universe, which plays into hands with the second principle: limitation. These particles are easy to provision and easy to measure. Interestingly, the first attempts to realize a quantum-processing unit with qubits did not choose these easy to handle electrons as carriers of the qubits, but much more complex superconducting quantum circuits on a wafer, which has to be cooled down close to absolute zero, to maintain more or less a decoherence time of the qubits, which one can work with. Additionally, the second principle is also very hard to achieve with the Q-ALU prototypes by IBM, Google and D-Wave, since the close to macroscopic elements of the integrated circuits simply have too much degrees of freedom. Therefore, the considerable efforts of these companies to build a practicable quantum-processing unit have not yet been successful.

According to implementations herein, a physically implementation of such a quantum arithmetic & logic unit consequential to the 3 given principles, with particles such as electrons, simple ions like Li+, Be+, H−, He⁺ or just protons, which are held in a force field, of a magnetic or electric character, and with no other connection to the environment, but addressable with photons, electrons and simple particles and quasiparticles is discussed.

Protons according to the aforementioned QIT are the third simplest particle in the universe, which thus fulfill the fidelity requirement of the 2nd principle. In this manner, implementations herein may use the spin of the proton as property to store the quantum information of the qubit. This is also true for simple electrons. In order to fulfill the 3rd principle of complexity with these very simple particles, the establishment of multi reference-based spin systems with complex magnetic fields is discussed (the spins then can be not only up and down, but have many superpositioned directions). The magnetic fields are easy to control within an integrated circuit, even at room temperature, and strong enough on their microscopic distances. It is shown in the aforementioned QIT that with these magnetic fields, aspects of such technology establish many superpositioned and entangled states on these simple and pure qubits. In this manner, the qubits align much better with the 3 principles.

Furthermore, it is shown that the effects are achieved with electrons in high temperature super conducting materials, making them possible to be easily cooled with liquid nitrogen, instead of the heavy-duty micro-Kelvin machineries needed in existing solutions.

Furthermore, according to the definitions of entanglement & superposition in Section 3, the gate creation and gate control in the present Q-ALU 430 is done with other quantum objects, such as photons and quasiparticles, coming from outside the Q-ALU. This allows the present

Gate Control Unit to zero-measure and error correct quantum states during the quantum calculation.

### 5. The Hybrid Quantum Processor Platform

The presently described theoretical construct called the universal quantum machine of FIG. 2 and the block diagram of the hybrid quantum processor of FIG. 4 represent the first universal architecture having practical and actual implementation for any quantum computer. Since the structure of Quantum gates can be implemented as arithmetic & logic functions in the Q-ALU 430, stored in the Gate creation unit 450, selected by the Bus control unit 410 and properly placed into execution by the Gate control unit 460, a ubiquitous set of quantum gate structures will be achieved with such universal Quantum computing system, which is referred to herein as the hybrid quantum processor and associated systems and platforms.

### Entanglement

A human brain, as a product of evolution in humans' macroscopic world, is specialized to perceive information from senses in order to match them with previous impressions and comprehend them with preinstalled or learned algorithms which lead to models of thinking and understanding the world around, what it is recently referred to as general intelligence. But in fact, the so-called generality of human mind holds humans back from the underlying realm of humans' conscious reality, the world of quantum physics. Like the famous quote of Richard Feynman insinuates: “I think I can safely say that nobody really understands quantum mechanics.”, humans are puzzled by the, by humans' perception, strange behavior of quantum systems, which could not be unraveled within the 20th century.

For the community of computer engineers, it is clear that at least the difference between classical and quantum information has to be understood in order to create such a thing like a Virtual Quantum Processor, which is identified to be desirable to be implemented as a foundation of a hardware agnostic Hybrid Quantum Computing Model.

Therefore, beginning with the things known about quantum entanglement, as one of the most important principles to speed up computers figured out, the simplest system of a quantum entangled state is a 2-particle system with just 2 plumbable qualities for each particle, which translates into a 2-qubit-system. With the physical notation of bra and ket (e.g., Bra-Ket) vectors, and the two possible outcomes of a measurement such as 0 & 1, the state of the entangled system S can be written as:

$$\vert S 〉 = α \vert 00 〉 + β \vert 11 〉 \qquad ( 1 )$$

Where α, β are normalized complex numbers, so that the sum of their complex conjugate squares equals the unit:

$$α {α}^{*} + β {β}^{*} = 1 \qquad ( 2 )$$

This is the quantum mechanical formalism to express what happens when a measurement of the State |S> takes place. The result can only be what a measurement apparatus allows to perceive, not what the quantum state “in reality” is. As the concept of reality implies what is measured, not the previous quantum state, which can be in a super position of possible measurement results or be entangled with other quantum systems. This definition of reality is due to a human's brain as an evolutionary product, which perceives what is measured by humans' senses. In fact, in order to measure the outcome of the quantum state, the measurement apparatus have to be entangled with the quantum system in question. This is also the reason, why a real measurement cannot be simulated with a deterministic Turing machine (DTM), since the outcome is purely probabilistic. But, some physical (quantum) system can be connected outside the DTM in order to retrieve a non-causal input regarding the computations at any given stage of its program. As soon as such a measurement is simulated, the probabilistic outcome of the state vector measurement can be decided, using this true random input, which extends the capabilities of the DTM to a non-deterministic one. The normalization of the coefficients α and β in (2) makes them available for the so-called Copenhagen interpretation of quantum mechanics, for their complex conjugate squares are interpreted as the probabilities for the possible outcomes, if one measures exactly for the given states |00> and |11>. Although it seems just to be a little formality, the difference between the notation of the quantum state in brackets, such as |00> and its corresponding measurement outcome 00 is enormous, since it distinguishes the quantum space with all its features like superposition, entanglement, non-locality and non-causality from classical, local and causal reality. Thus, it should be noted of this important differentiation in the notation as well as notion. Between |00> and 00 resides the measurement process, which is not only by technical means, but also conceptual a big step, elevating the system qualities from the quantum informational plane to the meta-informational, classical layer.

$$\begin{matrix}P ( 00 ) = α {α}^{*} & P ( 11 ) = β {β}^{*} \\ P ( 01 ) = 0 & P ( 10 ) = 0\end{matrix} \qquad ( 3 )$$

For In the language of information theory, one can also say that w the quantum system is queried, in which of these states it may present itself to the measurement apparatus. The answer of the quantum system can then be derived from the interaction between itself and the measurement apparatus. In this (inter)action, both of them will be forced into new quantum states, meaning, both of them will be changed simultaneously.

Now, the state |S> in (1) is an entangled one, since it is constituted by two quantum systems, which can be both in the states |0> and |1>. In the non-entangled case, this would correspond to four possible outcomes of the two independent quantum systems, namely |00>, |10>, |11> and |01>. But since the quantum systems are represented by the state |S>, they are fully entangled. This means, if one of the two systems are measured, the other systems future is determined. For any measurement, which takes place after that, the answer will be the same as with the previously measured quantum system, as long as the same question has been asked, which means, the same quality of the system has been measured.

One thing for human's perception is, that this quantum mechanism of entanglement functions over arbitrary distances in no time. But this does not mean that quantum entanglement is weird or spooky, as Albert Einstein stated, it just reminds humans on their own functional principles of human's brain, retrieving information only from measurements in space-time. This type of information is referred to as classical, while the information within the state vector of a quantum system, or a qubit, it is discriminated as quantum information.

### Quantum Information

It is learned from these observations of quantum systems that there is a profound dependency between classical and quantum information. Thus, the question for the best technical implementation of Hybrid Quantum Computers should be derived from the exact understanding of the dependencies between a bit of classical information b and a bit of quantum information |b>.

In order to retrieve b, one has to measure |b>. In a so-called classical world, only b is perceived. But in fact, all things and humans in this universe are quantum systems, regardless of their size. The only difference between the ‘macroscopic’ and the ‘microscopic’ world, which is again a distinction based on the size of human bodies and thus purely subjective, is simply the number of quantum measurements per unit time, or particle interactions in the terms of classical physics. Therefore, humans are used to a myriad of automatically carried out quantum measurements within human macroscopic bodies, which give humans the imagination of a smooth, nowadays called analog, reality of a world consisting of arbitrary amounts of features. But this is an illusion.

The same is true for computers. If it wasn't for the fact of the self-acting ongoing interactions between the elementary particles in integrated circuits, the quantum computer is to be invented first, in order to retrieve the classical information to calculate with. But integration efforts already led the technology to the point, where interactions between the electrons in integrated circuits and the crystal lattice become less probable, which leaves time for quantum effects, like the unwanted tunneling of electrons through the insulated gate of a MOSFET.

As seen now, classical correlates to quantum information as meta information, since classical information would not exist without quantum information, but the other way around, there is no restriction. Apart from this distinction, classical information functions as a subset of quantum information. Since in computer and data science, the concept of meta information is known, now it becomes much clearer how classical and quantum information should be dealt with within computational models. Like the instruction set of a classical processor represents the meta information to the data processed, classical information represents the meta information on quantum information processed. Actually, there is no need to separately process them, if the processor has the capability of both, classical and/or qubit registers. This insight obviously possesses fundamental influence to future quantum processor developments, but is also very valuable for the following discussion of a generalized Hybrid Quantum Computing Model.

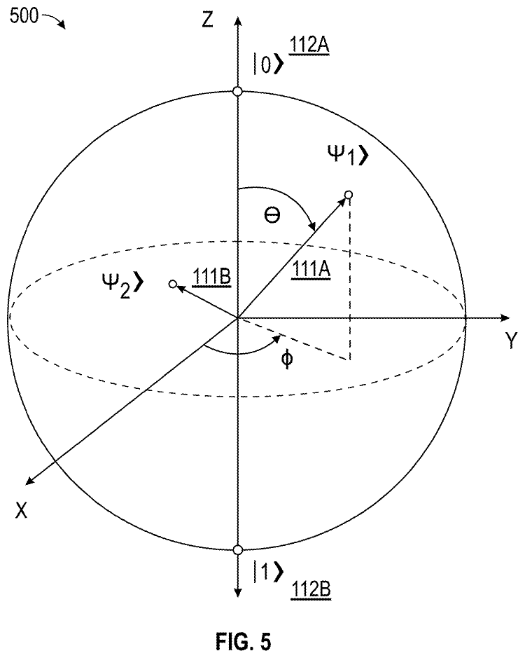

Referring next to FIG. 5, a diagram illustrating a Bloch sphere 500, consistent with exemplary aspects of certain embodiments of the disclosed technology, is shown. In this illustrative embodiment, a Bloch sphere may be utilized to guide efforts with the unification of classical and quantum computation. Here, for example, the quantum states, represented by the vectors |ψ>, just maintain two possible classical values after a measurement, namely 0 and 1 at the opposite directions of the z-axis.

It is important to note that these opposite directions represent orthonormal measurement outcomes, since one can only measure 0 exclusive or 1. In fact, one could measure any axis trough the origin of the sphere, but since this reflects a rotationally symmetric action, the given example is ubiquitous. One more thing is important as well: there is a fundamental difference between the quantum states |0> and |1>, at 112A and 112B, of the state vector |ψ>111 and the classical states 0 and 1 of a bit, after the measurement of the qubit. During a quantum computation, the state vector can reach any point on the Bloch sphere, without being measured. If it resides, e.g., at |0>112A and the qubit is measured, a classical 0 may be obtained as an output. But if the qubit is not measured, classical information in space-time cannot obtained. For any other place on the sphere, where the angle θ differs from zero, the probability of a 0-measurement P(0) is:

$$P ( 0 ) = Ψ {Ψ}^{*} = \frac{1 + cos ( θ )}{2} \qquad ( 4 )$$

As such, this probability is equal to the proportion of the surface on the Bloch sphere below the circle of latitude, where |ψ> points to, and the complementary section above. In other words, the integral over all state vectors on the Bloch sphere equals to the unit 1. The physical meaning by this is simply that if one asks a quantum system about its state, one will retrieve for sure an answer. But there is a subtler feature with the probability equations (3) and (4): since a probability means always a ratio between some elements of a set and the whole set. Thus, the whole of a set of quantum information must be definite.

### Third Quantization

This feature of quantum information reflects the simple fact that it is quantized, but leads ultimately to an important technical implication, which has been first described by Werner Heisenberg as the uncertainty principle:

$${σ}_{E} \cdot {σ}_{t} \geq \frac{ℏ}{2} \qquad ( 5 )$$

Here, the σ′ stand for the standard deviations of the energy (E) and time (t). As one can see, they cannot get arbitrarily low, since there is a small but finite limit set by the half of the reduced Planck constant. Energy and time are a pair of such complementary, or so to say canonically conjugated variables of physics. The meaning of this unfolds exactly during the measurement process: within the same measurement, one has to content oneself with a certain precision for the outcome, which is classical information. This is a fundamental principle of the universe, not an inadequacy in a measurement process, which could be improved later. In other words, the number of distinguishable outcomes of measurements of any quantum system is finite, as long as the quantum system itself consists of a finite amount of energy and there is only finite time to measure it, which both holds in any case, obviously.

This concludes the observation from the probability equation for the qubit measurements. Furthermore, one could reason, only a limited amount of classical information can be obtained out of a quantum system due to the uncertainty principle, the whole quantum system does not need to maintain more quantum states then necessary to provide with this amount of information. Of course, it would even shed more light to the whole mystery of quantum information theory, if it is to assume, that the finite amount of quantum information, every particle, molecule, planet, star or galaxy consists of, is the fundamental reason for the uncertainty principle and thus for the quantization of information in general, up to human consciousness.

Following this theory, the number of quanta inhered by a quantum system can be calculated in an observable universe. As used herein, the concept of quanta is referred to as the fundamental property of quantum fields, as shown in quantum field theory. Traditionally, this number of quanta has not been limited, but with insights from quantum information theory, the limit for the information content can be derived, a quantum system has to provide in order to be able to give plenty enough answers to possible measurement procedures. Since this information is quantized—let stand the capital letter I for the number of quanta—the minimum energy can be calculated, which means I=1, corresponding to a system in the observable universe, since its wave function is bounded by human perspective as observers and the event horizon, within one is able to make observations at all. Such a particle or quanta has its wavelength (2) from humans to the event horizon created by the big bang—or the starting point of the evolution of the universe, for any other cosmological theory—as follows:

$$\begin{matrix}λ = \frac{c}{H} & E = h \cdot v \cdot I & v = \frac{c}{λ} & ⇒ & E = h \cdot H \cdot I\end{matrix} \qquad ( 6 )$$

Here, c stands for the speed of light, H is the Hubble constant at the time of measurement, and the formula for the Energy (E) is the usual one with the Planck constant h and the frequency of the wave function (v), which translates in this particular case to H. For the ground state I equals one, and for the excited states I follows the natural numbers.

With Equation (6) there is a definite connection between any object in the universe, regardless of its appearance, as a field or a quantum system, with its information content, expressed by I and measured in the natural number of quanta. This may be called the Third Quantization, after the First Quantization initiated by Erwin Schrödinger and his wave equation and the Second Quantization brought to life by Paul Dirac as the occupation number representation and extended by quantum field theory as the canonical quantization. The Third Quantization represents all physical values in quanta, even for space-time itself, since all physical objects represent a certain amount of energy.

Thus, also qubits are inherently quantized and the number of possible state vectors (I) is defined by

$$\begin{matrix}I = \frac{Δ E}{h \cdot H} & with & Δ E = ‖ E ( \vert 0 〉 ) - E ( \vert 1 〉 ) ‖\end{matrix} \qquad ( 7 )$$

Here, ΔE represents the difference in energy between the two state vectors, which define the measurement values within the qubit and thus span the whole information space. It is noteworthy to realize that for such a physical qubit, or any quantum system, Hilbert space transforms to a discrete equivalent with Third Quantization.

Thus, any measurement along the z-axis forces the quantum system (qubit) into one of the quantum states |0> or |1>. But in the contrary to the mainstream literature of the 20^{th} century, where the term of collapsing wave functions was coined, the qubit endures with its state vector and thus its wave function stays intact, but now being identified after the interaction with the measurement apparatus and in fact both, the qubit and the measurement mechanism remain entangled for a while, until one of them faces another encounter with another gear of the quantum machine or the rest of the universe. So, if the qubit has been measured 0 and left undisturbed ever since, the next measurement should also be a 0 value. For physical implementations of qubits, this can differ, but is then recognized as erroneous behavior of the qubit. The average time to this malfunction from the last 0-readout is called T1. Such errors occur plenty with current physical qubit implementations in native quantum registers, but they are not of interest in the following discussion about a Uniform Quantum Computing Model, where it is assumed that quantum registers to be free of errors. Those are ignored at this stage, but the possibility of such unwanted influences from the rest of the universe into quantum computer is noted, which is described in the following.

### Virtual Quantum Processor

Consistent with exemplary aspects of certain embodiments of the disclosed technology, motivation to abstract from the physical implementation of a quantum processor may be twofold: first, it is known that the limitations and erroneous behavior of native quantum registers will improve with the advancements in engineering and manufacturing. As well as they are very much dependent on the topology of the qubits. While it is useful to emulate such physical systems, what can be done with quantum computer simulators in order to mitigate these errors in future applications, in the field of high-performance gate-based quantum computing these examinations are gratuitous. Although, there has been developing another discipline of quantum computing lately, the so-called ‘analogue’ quantum computing, which prepares a native quantum processor with all its errors as it is, in order to calculate a very special problem, this is not considered as a universal quantum computing system, as the gate-based variant of interest.

Second, all the functions of a quantum processor can be integrated into a unified processor model, so that it is emulated it and/or any simulated parts of the model can be exchanged, such as quantum registers, by appropriate physical implementations at any time, without changing any part of the whole computational stack above. Both aspects concentrate on the development of a theoretically optimized high-performance universal quantum computing system, from which the needed technological implications for its parts can be better anticipated, as doing it the other way around, which is the case now in the industry, to find suitable applications for the Noisy Intermediate Scale Quantum Computer (NISQ), which are state of the art right now systems.

Additionally, with this approach, today's ready high-performance computing technology is used to implement this novel Unified Quantum Computing Model by its own means. The groundwork for this is the insight about the nature of classical information as meta information to quantum information and its unique act of being created during the measurement process. The insight of the Third Quantization allows estimation of the needed resolution of such a virtual qubit, in order to mimic the quantum system within a Turing machine.

According to (6) and (7), e.g., a RF qubit with a 1 GHz range between its |0> and |1> state, inheres approximately 2 to the power of 90 possible quantum states, or in other words, with 90 classical bits, a Turing machine is capable of simulating the quantum bit (qubit) with no lack of accuracy. Of course, the actual readout accuracy of a physical qubit is many orders of magnitude lower and thus can be much easier emulated. On the other hand, a Turing simulated qubit with single (32 bit), or even double (64 bit) precision floating point representation is much better off than any of today's NISQ implementations.

The upshot is that both an image of quantum and classical information can be stored within a classical memory. But this alone does not give a quantum computer. Quantum computers and virtual quantum processors, consistent with the technology disclosed herein, are additionally configured for:
A. initializing qubits with classical meta information
B. initializing gate circuits between the qubits with classical meta information
C. processing the given quantum circuit by transforming all qubits by unitary matrices
D. measuring the qubits to retrieve classical information
E. processing classical information

Literature sometimes refers to a Quantum Turing machine as a deterministic Turing machine with the exchange of the classical discrete bit space by a Hilbert space. But, this isn't sufficient. According to some exemplary aspects of certain embodiments of the disclosed technology, one of the novelties simplifies the simulation of qubit registers by the merge of an image of quantum and classical information within a classical memory. Of course, classically stored quantum information cannot be processed by a native QPU, but indeed by a virtual one.

In order to leverage the exponential advantage for certain quantum algorithms, a native QPU has to be integrated into such a system. Thus, one of the exemplary technical solution provided herein is the hereby described Uniform Quantum Computing Model, which lets the applications run with, for example, both inbuilt virtual and native quantum processors, in parallel.

The second inaccuracy is the needed indeterminism for the measurement procedure. This can be implemented into today's high-performance deterministic Turing machines, since a simple sensor readout within the chassis with fluctuating bits of the length of the qubit accuracy will provide an adequate randomness for measurement simulation.

Referring back to FIG. 2, a block diagram illustrating an exemplary universal quantum machine, consistent with exemplary aspects of certain embodiments of the present disclosure, is shown. In this illustrative embodiment of FIG. 2, an exemplary native QPU may be used, for example, via plugging it into an exemplary model for a Universal Quantum machine as shown in FIG. 2, in order to be precise. Here, because this precision regarding the full or part of functionality of a native quantum computer and the information theoretical complexity of its components, any such part of the native quantum processor may be replaced by an adequate simulation, which will be optimized in performance for the, for example, Advanced Quantum Inspired Computing (AQIC).

According to exemplary aspects of certain embodiments of the disclosed technology, the third feature of native quantum computers, which is not represented within the conventional Turing model, is the measurement process. There, the uniqueness of quantum information may be incorporated in the universe. This means, if one measures a native qubit, one can influence/entangle with its stored quantum information, in order to perceive its meta representation into a measurement apparatus as classical information. This is the reason, why native quantum information cannot be copied, like its classical counterpart. Any such process of copying inheres a readout, which changes the source instantaneously. But of course, a classical image of the quantum information can be copied. It is possible to initialize a qubit, according to the precision of the apparatus, with very high accuracy as a physical representation of a quantum information image within the classical memory.

Under these aspects, it is possible to create a close-to copying mechanism for native quantum information, where the accuracy of the copying process is higher than the gate fidelity, and thus functions as a good enough approximation for a certain algorithm.

Based on above-set-forth features of A through E, FIG. 2 illustrates an exemplary resulting block diagram of such a Universal Quantum machine. Here, in this illustrated embodiment, the Universal Quantum machine may comprise the parts apart from the read-write tape 230 (2A) to be the actual quantum processor. With the read-write tape 230 (2A), the Universal Quantum machine may process classical information and thus may be considered as a Hybrid Quantum Processor.

According to the concepts and relations between quantum and classical information, for example, as described above, it is manifest that classical algorithms are a subset of quantum ones. In a technological sense, one could use qubits of a quantum register just with their |0>|1> values and thus representing the duality of a classical—with a quantum bit.

For that reason, here, FIG. 2 depicts in fact an exemplary Universal Quantum machine, since it provides a classical memory 230 (2A) as well as quantum memory 220 (2E), which both can be technically implemented as random access memories (RAM).

In some embodiments, as specified in the above-described feature A, a component, e.g., shown at 264 (2D) and/or 260, initializes the random access qubit memory (QRAM) 220 (2E) by creating certain state vectors in its respective Bloch spheres, controlled by classical meta information, which, in some implementation, may represent or just represent the two degrees of freedom for each qubit, e.g., the two angles θ and Φ, which define the point where the state vector touches the surface of the Bloch sphere.

In some embodiments, as to the requirement in the above-described feature B, it is represented by, for example, the relation between the QRAM 220 (2E) and the quantum register 210 (2B). As to the above-described feature c, the processing of the quantum gates within the quantum register may be timed with the cycle generator 240 (2F). The measurement apparatus 250 (2C) may synchronously measure the above-described feature D, the qubits after the processing of the quantum circuit and stores the classical values into the RAM 220 (2A), which concludes the quantum part of the calculation and hands over to the classical post processing of the above-described feature E.

Now referring to FIG. 4, a block diagram of an exemplary hybrid quantum processor 400, consistent with exemplary aspects of certain embodiments of the present disclosure, is shown. Here, in this illustrated embodiment, within the technical implementation of an exemplary quantum processing unit (QPU), the qubits 3E and the quantum register 3B may be anticipated within one physical system, shown as the quantum gates 430. This is owed to the fact, that current quantum technological engineering skills are not yet sufficient to build a reliable QRAM.

Furthermore, the gate creation unit 450 (3G) and gate control unit 460 (3H) units may be certain hardware implementations, depending on the physical structure of the qubits, such as LASER or microwave pulse generators.

In this example, the bus control unit 410 (3A) may represent the classical cache memory and logic unit, which performs pre-processing and/or post-processing to the quantum circuits and connects the hybrid quantum processor to the external Turing machines, which handle large data transfers and storage needs to complement high-performance computing. Because this is what quantum computers are all about, for example, the highest performing information processing machines. In order to technically accomplish this goal, classical high-performance clusters (HPC) are merged with QPUs during the next crucial step.

### Uniform Information Processing

As previously mentioned, with the technological state, a high quality, high speed quantum processing unit are not implemented, still in the noisy intermediate scale quantum computing era (NISQ). It is known that the simulations of quantum computers on classical Turing machines still perform much better for real life use cases than any physical quantum computing equipment.

Regardless of the uncertain construction of future technologies, the relevant features of such a computing system are nevertheless described as above. Since a Turing machines are so powerful already, one can make use of both, the vast transactional calculation speed of HPCs and the inherent quantum information logic.

According to certain embodiments of the disclosed technology, aspects of the innovations herein may include and/or involve a Uniform Quantum Computing Model. Consistent with some aspects, for example, implementations may commonly store classical information alongside or along with (e.g., in association with) the classical representation of quantum information within Bloch registers (BREGs) and to compute these BREGs with a Virtual Quantum Processing Unit (vQPU). In some implementations, a Bloch sphere is built into an intermediate representation of a memory pattern within the main memory in such a way that associated same state vectors |ψ> are fully represented within the memory pattern along with the classical information |0> and |1>.

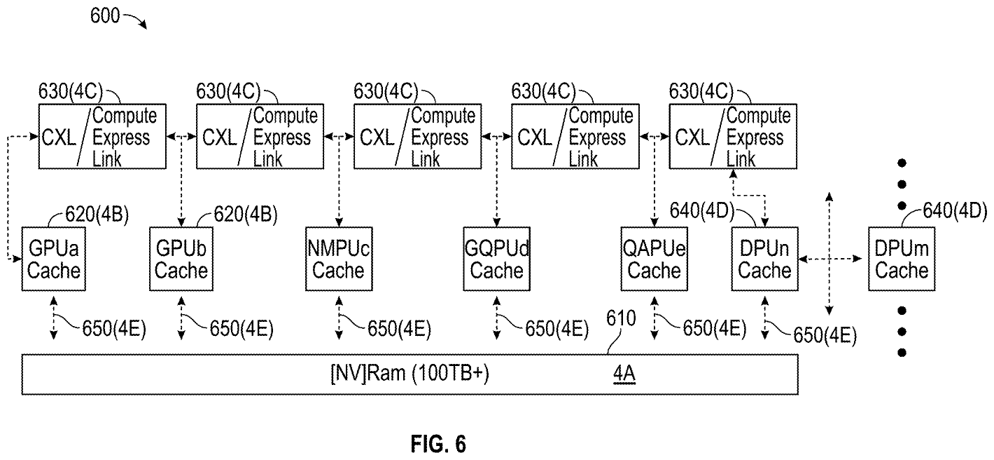

Now referring to FIG. 6, a block diagram 600 illustrating an exemplary set of Uniform Information Processing hardware, consistent with exemplary aspects of certain embodiments of the disclosed technology, is shown. According to certain embodiments, a vQPU may comprise the same technological components as shown in FIG. 4, but be implemented as software code within a large main memory of a Turing machine as depicted in FIG. 6. In this exemplary uniform computing architecture, as shown in this illustrated embodiment, the main memory 610 (4A) may be accessible by all and/or some of the different processing units 620 (4B) in the same manner and to its whole extent. Each of the processing units 620 (e.g., Central Processing Unit (CPU), Graphical Processing Unit; NMPU=NeuroMorphic Processing Unit; GQPU=Gate based Quantum Processing Unit (GPU); Quantum Annealing Processing Unit (QAPU); Data Processing Unit (DPU), etc.) may be either a physical implementation or a virtual processor. In some embodiments, the gate-based quantum processing unit may be analyzed as a virtual processor and all the others may be assumed as physical implementations. But it should be understood that one can follow the same logic for any other processing unit to be implemented as a virtual instance, without limitation.

In some embodiments, such as here, the minimum exemplary physical requirements may comprise the central main memory 610 (4A), at least one physical processing unit 620 (4B) (at the moment the most advanced ones are the CISC, RISC & Graphics processing architectures, etc.), the data processing unit 640 (4D) with its bridge functionality between the internal and external systems, and the memory bus systems 650 (4E) between the physical processing units 620 (4B) and the main memory 610 (4A). In some embodiments, such as those with underlying performance reasons, the cache coherency interconnect (CXL) 630 (4C) may also be physical, though this is not mandatory.

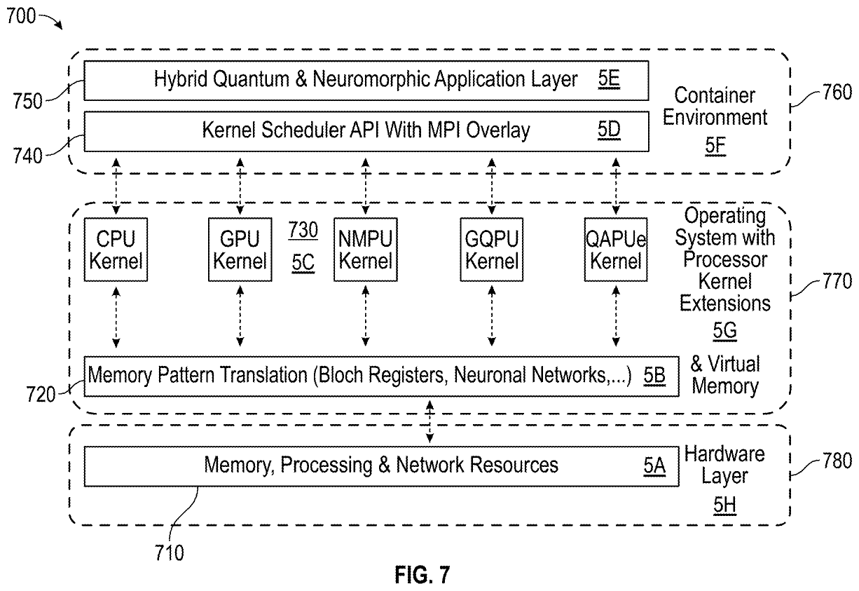

According to illustrative aspects of certain embodiments of the disclosed technology, with this exemplary architecture, the Uniform Computing Model may be implemented in general, as well as the one for Hybrid Quantum Computing, for example, in a very efficient and high-performance manner. All different types of processing units and furthermore any possible type of quantum processing unit, such as gate-based or annealing systems may be integrated in various embodiments. In some implementations, the physical type of the qubit registers may be irrelevant for its functionality, only performance and quality constraints will be passed through the computational stack, depicted in FIG. 7, below.

According to certain embodiments of the disclosed technology, this is possible due to the previously generic virtualization of the whole functionality of the quantum processors for any of the features A. through E., as above described, which may translate into an illustrative Turing machine's instruction set as follows.

Turning to FIG. 7, a block diagram 700 illustrating one exemplary Uniform Information Processing Stack, consistent with exemplary aspects of certain embodiments of the disclosed technology, is shown. In this illustrated embodiments, the following features and functionalities are described.

A. Initializing Qubits with Classical Meta Information

In some embodiments, this task may require the memory pattern translation 720, e.g., to Bloch registers. In implementations, current quantum circuit simulators may straightforwardly allocate the main memory for the storage of the linear matrices which are later being computed with exponential time, in case of entanglement occurrence. But this is not an optimized process regarding the specifics of a certain quantum circuit. For example, the resolution depth of a qubit could be reduced from double precision, which means 264 distinguishable points on a Bloch sphere, to e.g., 216 as a sufficient number. Such optimization parameters in the memory representation of quantum information may have to be provided as meta information from the application layer 750 via a kernel scheduler API 740 to the inner core or operating system of the Hybrid Quantum Operating System 770 (5G) in order to efficiently use the overall transactional computation power of the Uniform Quantum Computing Model. In some embodiments, the inner core or operating system 770 (5G) may be an operating system comprising processor kernel extensions and virtual memory, preferably including a memory pattern translation layer 720 (5B) and the Kernel Extensions 730 (5C). Further, as explained in connection with exemplary implementations, below, the container environment 760 (5F) may include or involve a kernel scheduler API, preferably with MPI overlay functionality, and an application layer 750 (5E), such as a hybrid quantum and neuromorphic application layer, as illustrated in the example embodiment of FIG. 7.

B. Initializing Gate Circuits Between the Qubits with Classical Meta Information

In such illustrative implementation, the same kernel scheduler API 740 (5D) may be used to transfer the required classical meta information for the quantum gate circuit to the memory pattern translation layer 720 (5B). In some aspects involving physical qubit registers, this information may be computed by the gate control unit 460 (3H) of FIG. 4 of the native quantum processor. In some embodiments, when the quantum processor is to be virtual, the gate matrices may be constructed with this information within the main memory of the Uniform Quantum Computer. This way, the processor hardware can be implemented with an agnostic architecture of this exemplary compute stack, such as above the kernel scheduler API.

### C. Processing the Given Quantum Circuit by Transforming all Qubits by Unitary Matrices

In some embodiments, in case of a native quantum processor, this is the task of its arithmetic and logic unit (ALU). Accordingly, the simulated QPU may be configured to utilize the same unit but as a piece of software in the processor kernel extensions of the hybrid quantum computing operating system, which is carried out by the means of the physical resources of a Turing machine, which is part, for example, or the whole of 710 (5A) (e.g., memory, processing and/or networking resources, etc.). Regardless of the physical implementation, the application layer 750 (5E) may make use of the kernel schedulers MPI overlay functionality, which provides the programmer all the useful and known methods of thread parallelization. This makes the Uniform Quantum Computing Model a real high-performance computing environment (HPC), where the programmer can distribute applications and also tasks within one application over arbitrary numbers of different processors and compute nodes with the same operating system 770 (5G) running on them. Via its processor kernel extensions and the virtual memory layer, the programmer may be able to utilize the full amount of compute resources to one single application and optimize its behavior with the exchange of relevant meta information between the application and the Hybrid Quantum Operating System.

### D. Measuring the Qubits to Retrieve Classical Information

For the community of computer engineers, it is clear that at least the difference between classical and quantum information has to be understood in order to create such a thing like a Virtual Quantum Processor, which is identified to be desirable to be implemented as a foundation of a hardware agnostic Hybrid Quantum Computing Model.

While in case of the native QPU this process is physical as well, the kernel extension of the Hybrid Quantum Operating System may be configured as capable of the analog procedure in a simulated environment, by means of the classical representation of quantum information, as described above. Here, though, it is noted that the memory pattern translation 5B is able to just read out the state vector. This is true and thus a feature of Advanced Quantum Inspired Computing, which saves time for certain algorithms, like the Quantum Approximate Optimization Algorithm (QAOA). But in building a hybrid quantum application, which will run on native and virtual QPUs simultaneously, one has to refrain from such unfair classical advantage, regarding native QPUs. But on the other hand, with the parallelization capabilities of the Uniform Quantum Computing Model, systems and methods herein perform even better and run the version of the application, which uses the shortcuts of AQIC automatically on the virtual QPUs and the other version of the same algorithm on the native QPUs simultaneously.

### E. Processing Classical Information

Here, in the exemplary Uniform Quantum Computing Model, this feature is provided since it represents the seamless merger of classical and quantum computing resources on the information theoretical level. But it is worth mentioning that the switching back and forth between sequences of classical and quantum information processing of the same compute thread is extremely fast and very close to its theoretical minimum within the Uniform Information Processing Stack, since the data between two such operations has not to be moved within the large amount of shared memory between all the different instances of processing units, called the Virtual Processor Instances (VPIs).

### Virtual Processor Instance

As explained above, in some embodiments, a VPI may comprise the processor kernel extension, a memory representation of the structure of a processing unit, irrespective of the physical implementation of such computational appliance. It may represent the essence of the functional structure of such a device, represented as software code within a high-performance Turing machine. On one hand, the VPI should not be seen as an emulation of a physical instance, since it dies not reproduce its unwanted, or in the case of quantum processors erroneous behavior while storing and processing quantum information. In fact, the VPI is an idealization of the device it represents, but with all functional aspects, which are desired from such a device. On the other hand, it is also not a simulator, since it just represents the functional structure of an idealized processing unit, not a fully-fledged computing system, which actually it is part of.

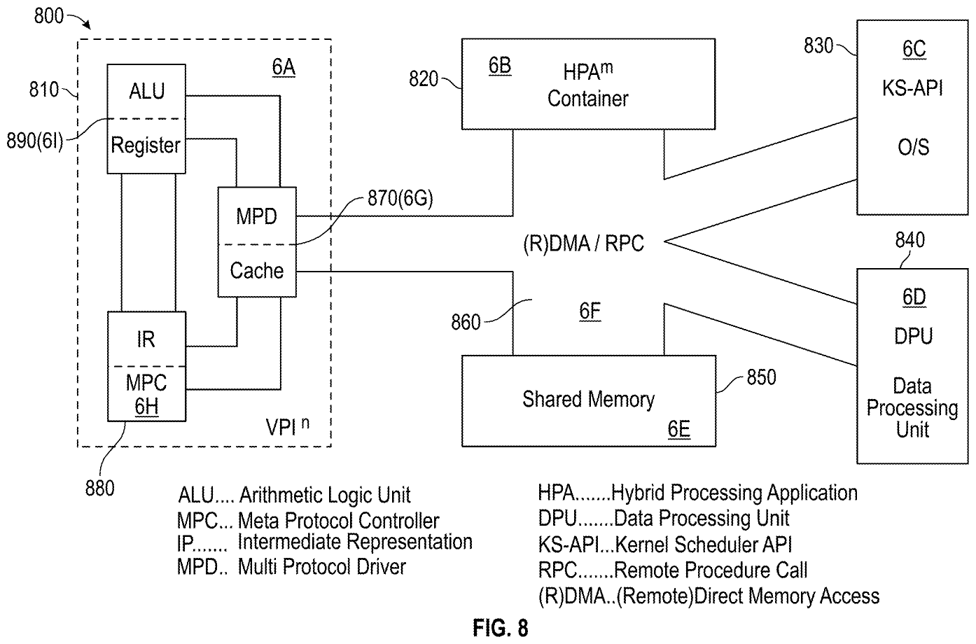

FIG. 8 is a block diagram 800 illustrating an exemplary virtual processor instance, consistent with exemplary aspects of certain embodiments of the disclosed technology. In this illustrative embodiment of FIG. 8, the VPI may integrated in the computing environment. Every one of these VPIs to the instance in 810 (6A) may have access to the full amount of main (e.g., shared) memory 850 (6E), so that the architecture implies shared memory features. The data transfer between the components of the computer is handled with direct memory access (DMA) over a suitable bus system 860 (6F), for example, a Memory Channel or PCIe. Thus, the architecture joins the group of Non-Uniform Memory Access (NUMA) constructions. Functions are executed on the optimal hardware for their type, favoring the non-moving data strategy of the Uniform Information Processing Model (UIPM) which holds also for instruction code. Thus, subroutines are preferably invoked over remote procedure calls (RPC). According to some embodiments, the VPIs 810 (6A) may be coherently constructed, regardless of their physical implementation, which can differ a lot from the idealized structure, represented within, for example, the respective Kernel Extensions 730 (5C) of FIG. 7. Since each of these elements have direct memory access and are terminated by the same software virtualization layer in the VPI, they are available for high-performance parallelization methods, like the message passing interface standard MPI, which is used by, for example, the Kernel Scheduler API 740 (5D) of FIG. 7. This API allows for the applications, which run parallel in the Hybrid Processing Container environment 820 (6B), to parallelize their threads into a universe of Virtual Processing Units on arbitrary many instances of the Kernel Scheduler API 830 (6C), respectively nodes of the whole operating system. Such an operating system with, for example, processor kernel extensions and virtual memory 770 (5G) of FIG. 7 is the first of its kind to span a homogenous and hardware agnostic abstraction (virtualization) layer over heterogenous physical and virtual processing units.

In some embodiments, both the physical and virtual processing units are represented by a functional memory pattern, the VPI 810 (6A) and, in some embodiments, comprises three major exemplary parts as follows:

### Multi Protocol Driver (MPD) 870 (6G)

In some embodiments, the MPD may function as the driver interface to the operating system 830 (6C), as well as may handle the communication between the VPI as a whole and its two other inner components. In some examples, it may be capable of the translation of the different protocols and functions as a switch between the internal components of the VPI and the external systems. The MPD may hold also the cache for the virtual processing unit, which is either be built by the MPD in memory, if there is no physical implementation of the VPI behind, or it may map the physical cache of a physical (quantum) processing unit into the main memory and thus provides cache coherency throughout the system, e.g., with a protocol like the Compute Express Link (CXL).

### Meta Protocol Controller (MPC) 880 (6H)

In some embodiments, the MPC may handle the meta information exchanged over the MPD and hold the Intermediate Representation (IR) for the information processing structures, such as quantum circuits, e.g., with the Quantum Assembly Language (QASM), or link patterns for neuronal networks. This meta information then may be handling the physical or virtual resources like qubits or neurons.

### Arithmetic & Logic Unit (ALU) 890 (61)

In some embodiments, the ALU, as with any processing unit, may be the core of the logic and arithmetic operations which are carried out between the registers of the processor. In the case of a gate-based quantum processor this may be linear algebra representation with matrix operations.

It should be understood that various of these exemplary, innovative systems and methods involving Uniform Information Processing Model(s) are well suited to simulate quantum computers with other hardware, such as matrix processing units (GPUs). In fact, such implementations may be utilized to implement algorithms, written for a specific hardware, to a totally different one and what performance impact the result is. Further, in some embodiments, the Data Processing Unit 840 (6D) may be used to connect many of such memory centric compute nodes to even larger, coherent central memory structures, which can span a whole data center facility with thousands of nodes.

According to various embodiments of the disclosed technology, new computing architecture(s) for high-performance, highly scalable applications in data centers is a turning away from nowadays execution centered operating systems in HPC nodes, which differ with, for example, any processor type in their singular kernels, toward a memory centric operating system with kernel extensions for every kind of processing unit, which are homogenously presented to the application layer and functionally stored in a single, central memory. Today's software development frameworks are fit to support the innovative operating systems and methods and new libraries will enable them to take vast advantage from the hybrid (quantum) computing approach.

According to various embodiments of the disclosed technology, applications built on such a novel Uniform Information Processing Platform may be able to run on its following versions to come, since the advances in hardware will just contribute to the speed-up of the apps but are veiled by the intermediate representation of the Virtual Processor Instance. Further, this does not hinder the programmers to add new features which are based on newer versions of the hardware and operating system—they will then be upwards compatible with the future generations of the system. This is a very promising feature for the industry, as it has been with the x86 architecture for more than 40 years, since it saves the investments made in software development, which are already well above a trillion Euros for the installed base which is in use today.

Further, this novel Uniform Quantum Computing Model facilitates huge potential from optimization with computation of hard problems w, since it allows for Advanced Quantum Inspired High-Performance Computing today, which then seamlessly transforms into hybrid quantum computing, without the need to rewrite the software, as soon as the new quantum processor technology is ready, e.g., for exhaustive data center usage.

As disclosed herein, unless disclosed to the contrary, implementations and features of the present inventions may be implemented through computer-hardware, software and/or firmware. For example, the systems and methods disclosed herein, or aspects, portions and/or involved components thereof, may be embodied in various forms including, for example, one or more data processors, such as computer(s), server(s) and the like, and may also include or access at least one database, digital electronic circuitry, firmware, software, or in combinations of them. Further, while some of the disclosed implementations describe specific (e.g., hardware, etc.) components, systems and methods consistent with the innovations herein may be implemented with any combination of hardware, software and/or firmware. Moreover, the above-noted features and other aspects and principles of the innovations herein may be implemented in various environments. Such environments and related applications may be specially constructed for performing the various processes and operations according to the inventions and/or aspects may include a general-purpose computer or computing platform selectively activated or reconfigured by code to provide certain features/functionality.

In the present description, usage of certain terms such as component, module, device, etc. may refer to various types of logical or functional device(s), process(es) or blocks that may be implemented in a variety of ways. For example, the functions of various blocks can be combined with one another and/or distributed into any other number of modules. A certain module, for example, may be implemented as a software program stored on a tangible memory (e.g., random access memory, read only memory, CD-ROM memory, hard disk drive) within or associated with the computing elements, etc. disclosed above, e.g., to be read by a processing unit to implement the functions of the innovations herein. Also, the modules can be implemented as hardware, logic/circuitry, etc. implementing the functions encompassed by the innovations herein. Finally, modules may be configured for use involving aspects such as special purpose instructions (SIMD instructions), field programmable logic arrays or any mix thereof which provides the desired level performance and cost.

Aspects of the systems and methods described herein may be implemented as functionality programmed into any of a variety of circuitry, including programmable logic devices (PLDs), such as field programmable gate arrays (FPGAs), programmable array logic (PAL) devices, electrically programmable logic and memory devices and standard cell-based devices, as well as application specific integrated circuits. Some other possibilities for implementing aspects include: memory devices, microcontrollers with memory (such as EEPROM), embedded microprocessors, firmware, software, etc. Furthermore, aspects may be embodied in microprocessors having software-based circuit emulation, discrete logic (sequential and combinatorial), custom devices, fuzzy logic, neural networks, other AI (Artificial Intelligence) or machine learning systems, quantum devices, and hybrids of any of the above device types.

It should also be noted that various logic and/or features disclosed herein may be enabled using any number of combinations of hardware, firmware, and/or as data and/or instructions embodied in various machine-readable or computer-readable media, in terms of their behavioral, register transfer, logic component, and/or other characteristics. Computer-readable media in which such formatted data and/or instructions may be embodied include, but are not limited to, non-volatile storage media in tangible various forms (e.g., optical, magnetic or semiconductor storage media), though do not encompass transitory media.

Other implementations of the inventions will be apparent to those skilled in the art from consideration of the specification and practice of the innovations disclosed herein. It is intended that the specification and examples be considered as exemplary only, with a true scope and spirit of the inventions being indicated by the present disclosure and disclosed examples/technology herein.

1. A virtual quantum computer system, comprising:
a main memory (610);
one or more memory bus systems (650) coupled to the main memory (610);
one or more physical processing units (620) that have access to the main memory (610), preferably via at least one memory bus system;
a data processing unit (640) coupled to at least one of the one or more physical processing units (620), the data processing unit (640) serving as a bridge between internal systems of the virtual quantum computer system and external systems;
one or more cache coherency interconnects (630) connecting the one or more physical processing units (620); and
an information process stack that comprises:
a hardware layer, an operating system coupled to the hardware layer and a container environment coupled to the operating system;
wherein the information process stack is configured to:
(A) initialize qubits with classical meta information;
(B) initialize gate circuits between the qubits with the classical meta information;
(C) process a given quantum circuit by transforming all qubits by unitary matrices;
(D) measure the qubits to retrieve classical information; and
(E) process classical information.

2. A virtual quantum computer system, comprising:
a main memory (610);
one or more memory bus systems (650) coupled to the main memory (610);
one or more physical processing units (620) that have access to the main memory (610), preferably via at least one memory bus system;
a data processing unit (640) coupled to at least one of the one or more physical processing units (620), the data processing unit (640) serving as a bridge between internal systems of the virtual quantum computer system and external systems; and
wherein a Bloch sphere is built into an intermediate representation of a memory pattern within the main memory (610) in such a way that associated same state vectors |ψ> are fully represented within the memory pattern alongside or along with the classical information |0> and |1>.

3. The system of claim 1 or 2, wherein:
the one or more cache coherency interconnects (630) comprise physical hardware components; and/or
the initialization of the qubits with classical meta information includes performing memory pattern translation (720), wherein, preferably, the memory pattern translation comprises translation to one or both of Bloch registers and/or neural networks.

4. The system of any of the preceding claims, wherein optimization parameters in a memory representation of quantum information are provided as meta information from an application layer (750) via a kernel scheduler (API 5D) to an inner core of the operating system (770) to efficiently use overall transactional computation power of the information process stack.

5. The system of any of the preceding claims, wherein the information process stack is further configured to:
transfer, via a kernel scheduler API (740, 830), the classical meta information required for the quantum gate circuit to a memory pattern translation layer (720) associated with the operating system (770).

6. The system of any of the preceding claims, further comprising physical qubit registers, wherein the classical meta information required for the quantum gate circuitry is computed by a gate control unit of a native quantum processor.

7. The system of any of the preceding claims, further comprising a virtual quantum processor, wherein gate matrices within the main memory are constructed with the classical meta information required for the quantum gate circuit, such that processor hardware is implemented with an agnostic architecture of the information process stack, preferably above the kernel scheduler API.

8. The system of any of the preceding claims, further comprising a quantum processing unit (QPU) that is configured to utilize an arithmetic and logic unit (ALU) as a piece of software in processor kernel extensions of a hybrid quantum computing operating system, preferably carried out by physical resources of the hardware layer (780).

9. The system of any of the preceding claims, wherein the container environment (760) includes a kernel scheduler API having MPI overlay functionality (740) that provides known methods of thread parallelization to a programmer, such that the programmer can distribute applications and/or tasks within one application over arbitrary numbers of different processors and compute nodes that run a same version of the operating system (770).

10. The system of any of the preceding claims, wherein, when running an application, the information process stack is configured to:
run parallel versions of the application on both virtual quantum processing units (virtual QPUs) and native quantum processing units (native QPUs),
wherein, preferably, when the application is being run via a native QPU, a memory pattern translation unit (720) is configured to read out state vectors; and/or
wherein, preferably, when the application is being run via a virtual QPU, the system is configured to utilize advanced quantum inspired computing (AQIC) shortcuts automatically.

11. The system of any of the preceding claims, wherein the information process stack is configured to:
store data utilized in different instances of native and virtual processing in shared memory using virtual processor instances (VPIs) comprised of processor kernel extensions.

12. The system of any of the preceding claims, wherein a memory pattern itself within the main memory (720) functions as meta-information for the respective processing units to control their execution of the data processed, such as to realize cache coherency, implement inherent intermediate representations or deliver information about topological dependencies to the control units of the processors, which, preferably, is configured for utilization by software developers to orchestrate different processing units accessing the same main memory most efficiently in parallel.

13. The system of any of the preceding claims, wherein a Bloch sphere (100) is built into an intermediate representation of a memory pattern within the main memory (720) in such a way that the same state vectors |ψ>(111) are fully represented within the memory pattern alongside or along with the classical information |0> and |1>(112).

14. The system of any of the preceding claims, wherein the information process stack is configured to:
store data in shared memory and process the data using virtual processor instances (VPIs), wherein the VPIs are processor kernel extensions comprising:
a plurality of subcomponents including a multi-protocol driver (MPD) (870), a meta protocol controller (MPC) (880), and an arithmetic and logic unit (ALU) (890); and
a bus system (860) configured to provide the subcomponents access to shared memory in the main memory and to handle direct memory access (DMA) exchanges involving the subcomponents.

15. The system of claim 14, wherein the multi-protocol driver (MPD) (870) is configured to:
function as a driver interface to the operating system (830);
handle communication between subcomponents of virtual processor instances (VPIs), including a multi-protocol driver (MPD) (870), a meta protocol controller (MPC) (880), and an arithmetic and logic unit (ALU);
translate different protocols;
switch between the subcomponents of the VPIs and the external systems; and/or
hold cache for the virtual processing unit.

16. The system of claim 15, wherein the virtual processing unit is configured to:
be built by the multi-protocol driver in memory, if there is no physical implementation of the VPIs; and/or
map physical cache of a physical (quantum) processing unit into the main memory and thereby provide cache coherency throughout the system.

17. The system of claim 15 or 16, wherein the meta protocol controller (880) is configured to:
handle the meta information exchanged over the multi-protocol driver (MPD) and hold an Intermediate Representation (IR) for the information processing structures, such as quantum circuits.

18. The system of any of the claims 15 to 17, wherein, when the system utilizes a gate-based quantum processor, the arithmetic and logic unit (ALU) (890) is configured to carry out logic and arithmetic operations using linear algebra representation with matrix operations.

19. A method of performing virtualized quantum processing, the method comprising:
initializing qubits with classical meta information;
initializing gate circuits between the qubits with the classical meta information;
processing a given quantum circuit by transforming all the qubits by unitary matrices;
measuring the qubits to retrieve classical information; and
processing the classical information;
wherein, preferably, the method is implemented via an information process stack, or computational stack, comprising: a hardware layer, an operating system coupled to the hardware layer, and a container environment coupled to the operating system.

20. The method of claim 19, wherein the processing of the classical information is performed by virtual hardware processors that are hardware agnostic, and wherein, preferably, the virtual hardware processors are implemented via a virtual quantum computer system comprising:
a main memory (610);
one or more memory bus systems (650) coupled to the main memory (610);
one or more physical processing units (620) that have access to the main memory (610), preferably via at least one memory bus system;
a data processing unit (640) coupled to at least one of the one or more physical processing units (620), the data processing unit (640) serving as a bridge between internal systems of the virtual quantum computer system and external systems;
one or more cache coherency interconnects (630) connecting the one or more physical processing units (620); and
the information process stack.

21. The method of claim 19 or 20, further comprising:
building a Bloch sphere (100) into an intermediate representation of a memory pattern within memory, such as the main memory (720), in such a way that the same state vectors |ψ>(111) are fully represented within the memory pattern alongside or with the classical information |0> and |1>(112).

22. The method of any of the claims 19 to 21, further comprising:
implementing a memory pattern within the main memory (720) to function as meta-information for respective processing units to control their execution of the data processed, such as, but not restricted to realize cache coherency, implement inherent intermediate representations or deliver information about topological dependencies to the control units of the processors, which, preferably, is configured for utilization by software developers to orchestrate different processing units accessing the same main memory most efficiently in parallel.

23. The method of claim 20, optionally in combination with claim 21 or 22, wherein the one or more cache coherency interconnects comprise physical hardware components.

24. The method of any of the claims 19 to 23, wherein the initialization of the qubits with classical meta information includes performing memory pattern translation (720), wherein, preferably, the memory pattern translation comprises translation to one or both of Bloch registers and/or neural networks.

25. The method of any of the claims 19 to 24, wherein optimization parameters in a memory representation of quantum information are provided as meta information from an application layer (750) via a kernel scheduler API (740, 830) to an inner core of the operating system (770), preferably to efficiently use overall transactional computation power of the information process stack.

26. The method of any of the claims 19 to 25, wherein the information process stack is further configured to:
transfer, via a kernel scheduler API (740, 830), the classical meta information required for the quantum gate circuit to a memory pattern translation layer (720) associated with the operating system (770).

27. The method of any of the claims 19 to 26, wherein the information process stack is further configured for implementation with physical qubit registers, wherein the classical meta information required for quantum gate circuitry is computed by a gate control unit of a native quantum processor.

28. The method of any of the claim 19 to claim 26, wherein the method is further implemented via a virtual quantum processor, wherein gate matrices within the main memory are constructed with the classical meta information required for the quantum gate circuit, such that processor hardware is implemented with an agnostic architecture of the information process stack, preferably above the kernel scheduler API.

29. The method of any of the claims 19 to 28, wherein the method is further implemented via a quantum processing unit (QPU) that is configured to utilize an arithmetic and logic unit (ALU) as a piece of software in processor kernel extensions of a hybrid quantum computing operating system, preferably carried out by physical resources of the hardware layer (780).

30. The method of any of the claims 19 to 29, further comprising: implementing the container environment (760) with a kernel scheduler API having MPI overlay functionality (740) configured to provides known methods of thread parallelization, preferably to a programmer, such that the programmer can distribute applications and/or tasks within one application over arbitrary numbers of different processors and compute nodes that run a same version of the operating system (770).

31. The method of any of the claims 19 to 30, wherein, when running an application, the information process stack is configured for:
running parallel versions of the application on both virtual quantum processing units (virtual QPUs) and native quantum processing units (native QPUs),
wherein, preferably, when the application is being run via a native QPU, a memory pattern translation unit (720) is configured to read out state vectors; and/or
wherein, preferably, when the application is being run via a virtual QPU, the system is configured to utilize advanced quantum inspired computing (AQIC) shortcuts automatically.

32. The method of any of the claims 19 to 31, wherein the information process stack is configured for:
storing data utilized in different instances of native and virtual processing in shared memory using virtual processor instances (VPIs) comprised of processor kernel extensions.

33. The method of any of the claims 19 to 32, wherein the information process stack is configured for:
storing data in shared memory and process the data using virtual processor instances (VPIs), wherein the VPIs are processor kernel extensions comprising:
a plurality of subcomponents including a multi-protocol driver (MPD) (870), a meta protocol controller (MPC) (880), and an arithmetic and logic unit (ALU) (890); and
a bus system (860) configured to provide the subcomponents access to shared memory in the main memory and to handle direct memory access (DMA) exchanges involving the subcomponents.

34. The method of claim 33, wherein the multi-protocol driver (MPD) (870) is configured for:
functioning as a driver interface to the operating system (830);
handling communication between subcomponents of virtual processor instances (VPIs), including a multi-protocol driver (MPD) (870), a meta protocol controller (MPC) (880), and an arithmetic and logic unit (ALU);
translating different protocols;
switching between the subcomponents of the VPIs and the external systems; and/or
holding cache for the virtual processing unit.

35. The method of claim 34, wherein the virtual processing unit is configured for:
being built by the multi-protocol driver in memory, if there is no physical implementation of the VPIs; and/or
mapping physical cache of a physical (quantum) processing unit into the main memory and thereby provide cache coherency throughout the system.

36. The method of claim 34 or 35, wherein the meta protocol controller (880) is configured for:
handling the meta information exchanged over the multi-protocol driver (MPD) and hold an intermediate representation (IR) for the information processing structures, such as quantum circuits.

37. The method of any of the claims 34 to 36, wherein, during implementations that utilize a gate-based quantum processor, the arithmetic and logic unit (ALU) (890) is configured to carry out logic and arithmetic operations using linear algebra representation with matrix operations.

38. A method of performing virtualized quantum processing, the method comprising:
implementing a virtual quantum computer system comprising a main memory (610, 720), one or more memory bus systems (650) coupled to the main memory (610), one or more physical processing units (620) that have access to the main memory (610), and a data processing unit (640) coupled to at least one of the one or more physical processing units (620);
implementing a memory pattern within the main memory (610, 720), including building a Bloch sphere into an intermediate representation of the memory pattern within the main memory in such a way that associated same state vectors |ψ> are fully represented within the memory pattern alongside or along with the classical information |0> and |1>.

39. A virtual quantum computer system, comprising:
one or more servers, computer processors, memory, and/or computer readable media configured to perform one or more portions, aspects and/or the steps of any of claims 1-38 and/or other features or functionality set forth elsewhere in the present disclosure.

40. A method of performing virtualized quantum processing, the method comprising:
perform one or more portions, aspects and/or the steps of any of claims 1-38 and/or other features or functionality set forth elsewhere in the present disclosure.

41. One or more computer-readable media containing and/or configured to execute computer-readable instructions, the computer-readable instructions comprising instructions that, when executed by one or more processors, cause the one or more processors to:
perform one or more portions, aspects and/or the steps of any of claims 1-38 and/or other features or functionality set forth elsewhere in the present disclosure.
